(19) United States
(12) Patent Application Publication
(10) Pub. No.: US 2026/0319815 A1
(43) Pub. Date: Oct. 15, 2026

(54) METHOD AND SYSTEM FOR GENERATING DIGITAL ASSET BASED ON USER BEHAVIOR

(71) Applicant: ASUSTeK COMPUTER INC., Taipei City (TW)

(72) Inventors: Wen-Chieh Wu, Taipei City (TW); Wen-Han Wu, Taipei City (TW)

(73) Assignee: ASUSTeK COMPUTER INC., Taipei City (TW)

(21) Appl. No.: 19/572,859

(22) Filed: Mar. 20, 2026

(30) Foreign Application Priority Data
Apr. 9, 2025 (TW) 114113419

(51) Int. Cl. G06F 9/451; G06F 11/34; G06F 21/62

(52) U.S. Cl. CPC G06F 9/451; G06F 11/3438; G06F 21/6254

(57) ABSTRACT

Disclosed are a method and a system for generating digital asset based on user behavior. The method comprises the following steps. User behavior data of an information system is collected through an agent module deployed on a user terminal device. The user behavior data is recorded into a database. A user interface flow is established based on the user behavior data in the database. Digital asset of information systems is generated based on the user interface flow.

### CROSS-REFERENCE TO RELATED APPLICATION

This application claims the priority benefit of Taiwan application serial no. 114113419, filed on Apr. 9, 2025. The entirety of the above-mentioned patent application is hereby incorporated by reference herein and made a part of this specification.

### BACKGROUND

### Technical Field

The present disclosure relates to a method and system for generating digital asset based on user behavior.

### DESCRIPTION OF RELATED ART

In the development of modern healthcare information systems (HIS), it is crucial to understand physicians' operational behaviors and requirements. When seeking to comprehend the various functions of healthcare information systems and utilization patterns of the systems, existing methodologies primarily rely on manual interviews and discussions, necessitating substantial time and human resources. Moreover, the outcomes of interviews and discussions are predominantly documented in natural language, lacking data substantiation, which may lead to imprecise requirement specifications. Furthermore, these processes typically fail to reflect physicians' actual operational patterns, potentially resulting in systems that do not align with practical needs. Additionally, existing methodologies are often confined to specific application contexts, unable to comprehensively encompass physicians' operational behaviors, and the data collection process frequently raises concerns regarding medical data privacy. These limitations render the requirements gathering process for healthcare information systems inefficient and imprecise.

### SUMMARY

The present disclosure provides a method for generating digital asset based on user behavior. This method comprises the following steps. User behavior data of an information system is collected through an agent module deployed on a user terminal device. The user behavior data is recorded into a database. A user interface (UI) flow is established based on the user behavior data in the database. Digital asset of information systems is generated based on the user interface flow.

The present disclosure provides a system for generating digital asset based on user behavior, including a storage device and one or more processors. The storage device records multiple instructions. The processor is coupled to the storage device and configured to execute the aforementioned instructions to perform the following operations. User behavior data of an information system is collected through an agent module deployed on a user terminal device. The user behavior data is recorded into a database. A user interface (UI) flow is established based on the user behavior data in the database. Digital asset of information systems is generated based on the user interface flow.

Based on the above, in the embodiment of the present disclosure, the agent module deployed on the user terminal device collects user behavior data while users operating the information system. Afterwards, the user interface flow of the information system is establishe according to the user behavior data, and digital asset of the information system, such as system specification, test cases or test scripts, is generated according to the user interface flow. In this way, the dependence on manual interviews is reduced, and the process of generating digital asset is automated to improve efficiency and accuracy.

### BRIEF DESCRIPTION OF THE DRAWINGS

FIG. 1 is a schematic diagram illustrating a system for generating digital asset based on user behavior according to an embodiment of the present disclosure.

FIG. 2 is a block diagram illustrating a user terminal device and a server device according to an embodiment of the present disclosure.

FIG. 3 is a flowchart illustrating a method for generating digital asset based on user behavior according to an embodiment of the present disclosure.

FIG. 4 is a schematic diagram illustrating the selection of key frames according to an embodiment of the present disclosure.

FIG. 5 is a schematic diagram illustrating a method for generating digital asset according to an embodiment of the present disclosure.

FIG. 6 is a schematic diagram illustrating a user interface flow according to an embodiment of the present disclosure.

FIG. 7 is a flowchart illustrating a method for generating digital asset based on user behavior according to an embodiment of the present disclosure.

### DESCRIPTION OF THE EMBODIMENTS

Some embodiments of the present disclosure will now be described in detail with reference to the accompanying drawings. In the following description, when the same element symbols appear in different drawings, they will be regarded as the same or similar elements. These embodiments are only a part of the present disclosure and do not disclose all possible embodiments of the present disclosure. More precisely, these embodiments are only examples of the systems and methods in the claims of the present disclosure.

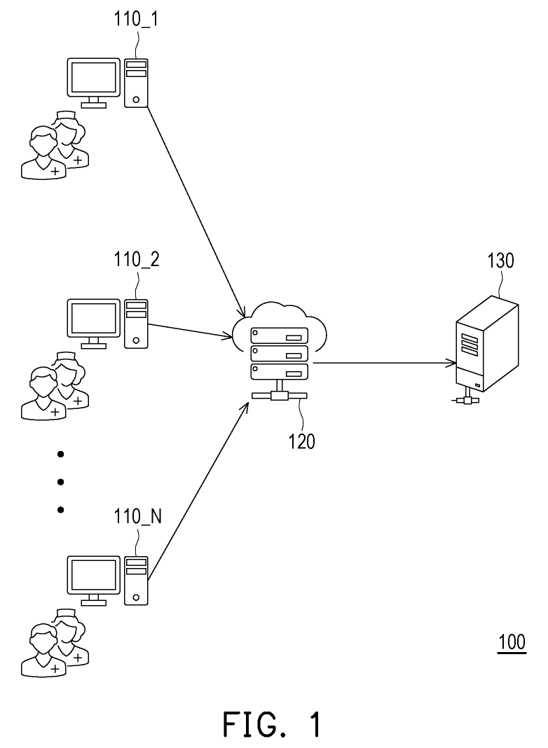

Referring to FIG. 1, in an embodiment, the system 100 for generating digital asset based on user behavior comprises at least one user terminal device 110_1 to 110_N, a storage server 120, and an analysis server 130.

In one embodiment, the user terminal devices 110_1 to 110_N are smartphones, laptops, tablet computers, desktop computers, or various personal computing devices, and so on, which are not limited by the present disclosure. The number of user terminal devices 110_1 to 110_Nis one or more, which is not limited by the present disclosure. The user terminal devices 110_1 to 110_N provide an interface for users to interact with the information system, allowing users to access the functions and data of the information system. In some embodiments, the user terminal devices 110_1 to 110_N collect user behavior data from the information system.

In one embodiment, the user terminal devices 110_1 to 110_N is connected to the storage server 120 through wired transmission interfaces or wireless transmission interfaces. In different embodiments, the user terminal devices 110_1 to 110_N is connected to the storage server 120 through a network. The network comprises any of various wireless and/or wired networks. In an embodiment, the network comprises any combination of public and/or private networks, local area networks and/or wide area networks.

The storage server 120 collects, stores, and manages user behavior data. In some embodiments, the storage server 120 is also implemented through one or more electronic devices with storage capabilities, such as specific Network-Attached Storage (NAS), storage area network (SAN), or cloud storage services (such as AWS S3, Google Cloud Storage), etc.

The storage server 120 is connected to the analysis server 130 through wired transmission interfaces or wireless transmission interfaces. In different embodiments, the storage server 120 is connected to the analysis server 130 through a network. The network comprises any of various wireless and/or wired networks. In an embodiment, the network comprises any combination of public and/or private networks, local area networks and/or wide area networks.

The analysis server 130 analyses user behavior data to generate digital asset of the information system, such as UI Flows, system specifications, test cases and test scripts, etc. In some embodiments, the analysis server 130 is also implemented through one or more electronic devices with computing capabilities. In some embodiments, the storage server 120 and the analysis server 130 are implemented through a single independent server equipment with both storage and computing capabilities.

The following will mainly use the user terminal device 110_1 as an example for explanation, but the same operations and embodiment are also applied to other user terminal devices 110_2 to 110_N.

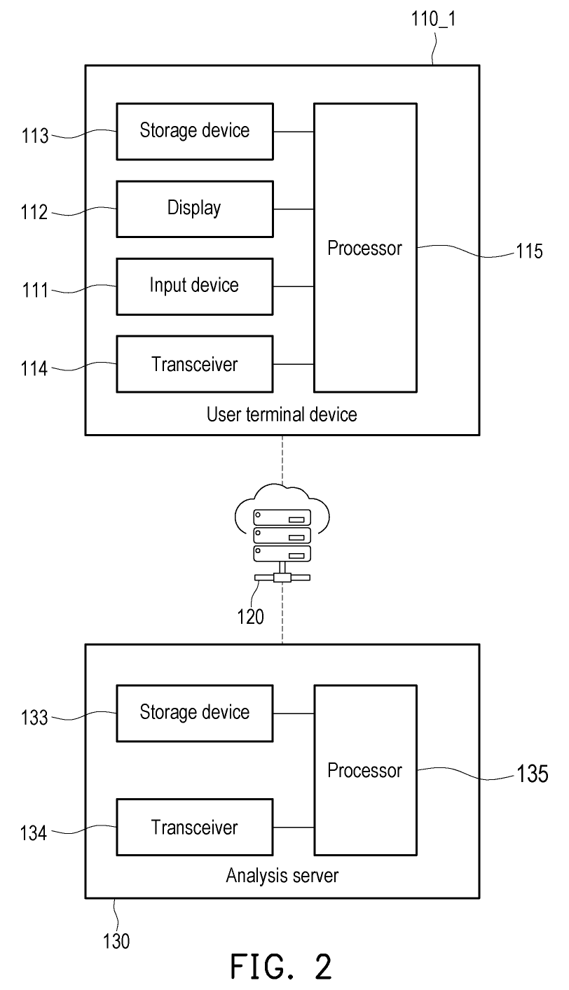

Please refer to FIG. 2, which is a block diagram of a user terminal device and a server device as illustrated in an embodiment of the present disclosure. The user terminal device 110_1 comprises an input device 111, a display 112, a storage device 113, a transceiver 114, and a processor 115. The analysis server 130 comprises a storage device 133, a transceiver 134, and a processor 135.

The input device 111 is configured to receive user operations, such as a mouse, keyboard, or touch device, etc.

In one embodiment, the display 112 is a Liquid Crystal Display (LCD), a Light-Emitting Diode (LED) display, an Organic Light-Emitting Diode (OLED) display, or other types of displays, which is not limited by the present disclosure. In the embodiment of the present disclosure, the display 112 displays the user interface of the information system. In other words, the display 112 displays multiple operation pages of the information system.

The storage device 113 is used to store data, software modules and so on accessible by the processor 115. The storage device 133 is used to store data, software modules and so on accessible by the processor 135. In an embodiment, the storage devices 113 and 133 are any form of fixed or removable random access memory (RAM), read-only memory (ROM), flash memory, hard disk, or a combination thereof.

The transceiver 114 and the transceiver 134 transmit and receive signals in a wireless or wired manner. The transceiver also performs operations such as low noise amplification, impedance matching, mixing, upward or downward frequency conversion, filtering, amplification, and similar operations. The user terminal device 110_1 receives and transmits data through the transceiver 114, and the analysis server 130 receives and transmits data through the transceiver 134, such as transmitting and receiving data via the Internet, etc.

The processor 115 is coupled to the input device 111, the display 112, the storage device 113, and the transceiver 114. The processor 135 is coupled to the storage device 133 and the transceiver 134. The processor 115 and the processor 135 is, in an embodiment, a central processing unit (CPU), an application processor (AP), or other programmable general-purpose or special-purpose microprocessor, a digital signal processor (DSP), an image signal processor (ISP), a graphics processing unit (GPU) or other similar devices, integrated circuits and combinations thereof.

In some embodiments, the processor 115 and the processor 135 access and execute software modules to implement the method for generating digital asset based on user behavior in the embodiment of the present disclosure. The above-mentioned software modules is broadly interpreted to mean instructions, instruction sets, code, program code, programs, applications, software packages, threads, processes, functions, etc.

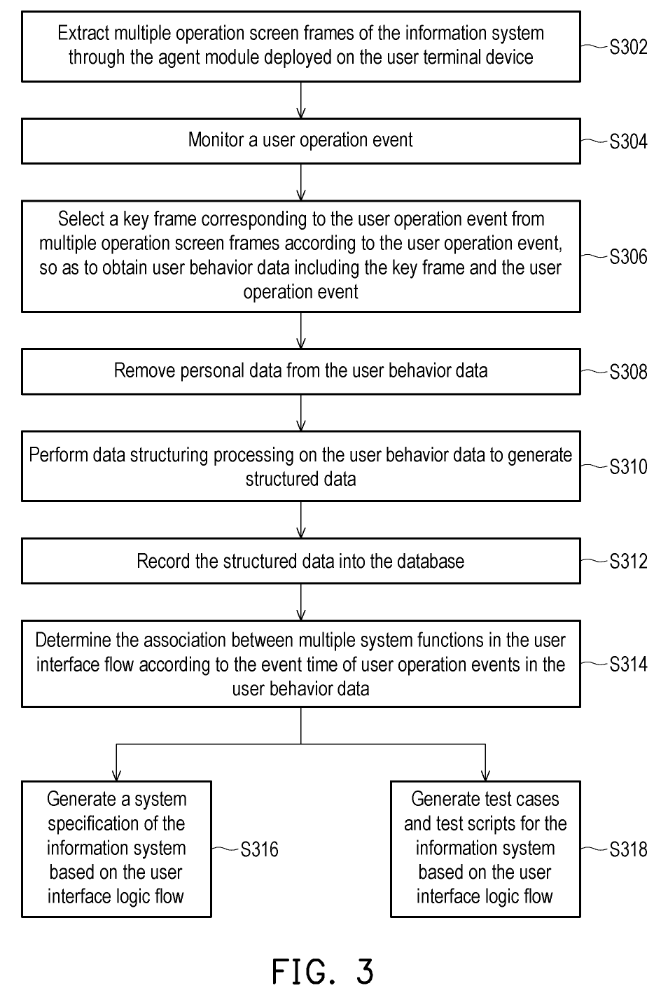

Please refer to both FIG. 1 and FIG. 3, the method of this embodiment is applied to the above-mentioned system 100 for generating digital asset based on user behavior. The following will explain the detailed steps of the method for generating digital asset based on user behavior in this embodiment in conjunction with various components of the system 100 for generating digital asset based on user behaviour.

At step S302, through the agent module deployed on the user terminal device 110_1, the user terminal device 110_1 extracts multiple operation screen frames of the information system. The agent module is a software element deployed on the user terminal device 110_1. Specifically, when a user uses the information system, the user terminal device 110_1 displays the operation window of the information system. In some embodiments, the agent module of the user terminal device 110_1 extracts multiple operation screen frames of the information system at fixed time intervals. Alternatively, in some embodiments, the agent module of the user terminal device 110_1 extracts multiple operation screen frames of the information system in response to extraction conditions being met. In an embodiment, the above extraction conditions are significant changed in the window screen or receiving user operation events, etc.

In some embodiments, the information system comprises a hospital information system (HIS). The hospital information system is an information management system specifically designed for medical institutions, involving functions such as patient management, electronic medical record (EMR), medical order management, financial settlement, and so on.

At step S304, the agent module of the user terminal device 110_1 monitors a user operation event. Specifically, when the input device 111 receives a user operation, the agent module of the user terminal device 110_1 monitors a user operation event.

In some embodiments, user operation events comprise mouse click events, touch click events, or keypress events. In an embodiment, when a user clicks on a button, form, or menu on the user interface of an information system via a mouse or touchpad, the agent module detects a click event. When text is entered in an input field, the agent module detects a keypress event. When a user performs clicking, swiping, or zooming operations via a touch screen, the agent module detects a touch event.

In the application scenario of the hospital information system, the agent module of the user terminal device 110_1 is used to monitor the user operation behavior of medical personnel. The above user operation behavior is, in an embodiment, a doctor clicking on the "Patient Query" interface, inputting the patient's name and searching, or a nurse clicking the "Medication Record" button to confirm the patient's prescription record.

At step S306, the agent module of the user terminal device 110_1 selects a key frame corresponding to the user operation event from multiple operation screen frames according to the user operation event, so as to obtain user behavior data including the key frame and the user operation event. Specifically, when the agent module detects a user operation event, such as a mouse click event, a touch click event, or a keypress event, the agent module instantly extracts the current operation screen frame and marks the current operation screen frame as a key frame related to that user operation event.

In some embodiments, the agent module identifies key frames through an event-driven approach. In an embodiment, when a user clicks a button on the operation page of the information system, the agent module extracts and marks the operation screen frame while the click occurs. Additionally, if a user inputs text in a search field, the agent module extracts and mark the current operation screen frame when the user presses the "Enter" key or clicks the search button.

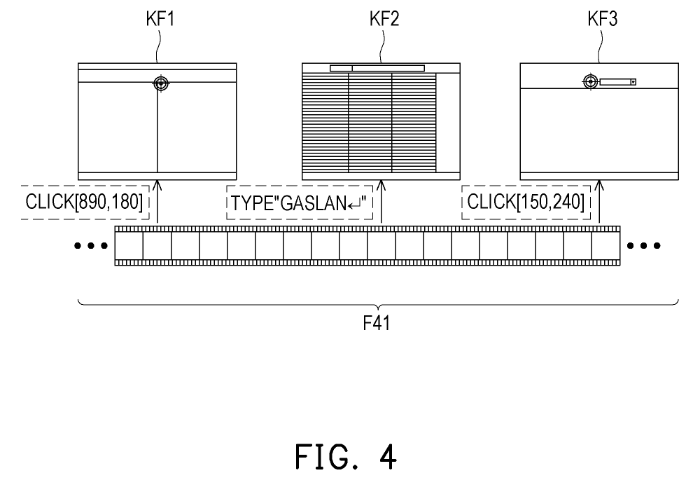

Please refer to FIG. 4, which is a schematic diagram illustrating the selection of key frames according to an embodiment of this disclosure. The agent module of the user terminal device 110_1 extracts multiple operation screen frames F41. The agent module selects key frames according to user operation events to record screen content corresponding to the user operation events. In this example, the agent module selects three key frames KF1, KF2, and KF3, which correspond to three different user operation events.

As shown in FIG. 4, when the agent module detects that the user performs a click event at coordinate position [890,180], the agent module selects the operation screen frame at the time of the click event as key frame KF1, so as to record the specific location and corresponding UI element that the user clicked on that operation page. When the agent module detects that the user has entered the text "GASLAN" in the search field and pressed the Enter key to submit, the agent module selects the operation screen frame at the time of pressing the Enter key as the key frame KF2. When the agent module detects another click event at coordinate position [150, 240], the agent module selects the operation screen frame at the time of the click event as the key frame KF3.

Thus, through the key frame selection process, the agent module establishes associations between multiple user operation events and key frames, forming structured user behavior data. In some embodiments, the user behavior data comprises information such as operation timestamps, operation types, and screen content of key frames.

At step S308, the agent module of the user terminal device 110_1 removes personal data from the user behavior data. Specifically, the agent module of the user terminal device 110_1 identifies and remove data fields or elements that contains personal information through data processing and cleaning mechanisms. In one embodiment, the agent module analyses whether there is personal data of patients or doctors in the user behavior data, the above personal data comprises but is not limited to the user's name, account, email address, IP address, and other personal identification information. The agent module of the user terminal device 110_1 removes personal data from the user behavior data through data masking or data deletion. In an embodiment, the agent module of the user terminal device 110_1 replaces sensitive information with anonymous markers. Alternatively, the agent module of the user terminal device 110_1 directly removes data fields containing personal data, such as deleting IP addresses or device identifiers that are irrelevant to operation events.

At step S310, the storage server 120 performs data structuring processing on the user behavior data to generate structured data. At step S312, the storage server 120 records the structured data into the database. Specifically, the user terminal device 110_1 transmits the user behavior data to the storage server 120. The storage server 120 converts the original user behavior data into a structured data format that facilitates retrieval and analysis, thereby improving the usability and analysis efficiency of the data.

In some embodiments, data structuring processing comprises classifying, organizing, and formatting the user behavior data. In an embodiment, the storage server 120 breaks down each operation event data in the user behavior data into standardized fields, such as "event type," "operation timestamp," "operation location," "operation target," and "key frame". Additionally, for screen frame data, the storage server 120 establishes corresponding indexes with user operation events, ensuring efficient retrieval of user operation events and visual data. The data after being subjected to the structuring process will be stored in the database.

At step S314, the analysis server 130 determines the association between multiple system functions and operation pages in the user interface flow (UI Flow) according to the event time of user operation events in the user behavior data. Specifically, the analysis server 130 reconstructs the complete UI Flow of user operations in the information system by analyzing the timestamps and execution sequence of user operation events in the user behavior data. Specifically, the analysis server 130 combines user operation events with one or more corresponding key frames, and establish the navigation and interaction relationships between operation pages through time series analysis of user operation events. In some embodiments, the analysis server 130 identifies the navigation relationships between different operation pages by arranging user operation events in chronological order, thereby inferring the relative dependencies of different system functions based on the user’s operation actions. In an embodiment, if a user frequently navigates from a first operation page to a second operation page of a specific function module, the analysis server 130 determines that the function module has a high correlation with the first operation page in the UI Flow. Specifically, the first operation page is the main entry to the function module. Alternatively, the user habitually enters the second operation page from the first operation page, indicating that these two pages have logical continuity in user behavior. Or, the second operation page is the main extended function of the first operation page.

In some embodiments, the analysis server 130 finds candidate UI elements by analyzing rectangular contours in key frames, and finds target UI elements based on the coordinate locations of user operation events. The coordinate location of a user operation event approximately is located within the central area of the target UI element. In some embodiments, the analysis server 130 identifies a specific system function of the information system by analyzing the displayed text or icon in the target UI element and the subsequent operation page. In some embodiments, the analysis server 130 analyses rectangular contours in key frames to find a window range of a window, and identifies the window title of the window to determine the system function to which the operation page belongs.

In an embodiment, when a user clicks a button, the user behavior data records the event time and operation coordinates of the click. The analysis server 130 combines subsequent screen changes (such as page navigation or window updates) to determine the logical relationship between the click operation and subsequent operation pages. The establishment of these operation pages and associations forms a clear user interface flow to describe the user's operation path in the information system. Based on this, the user interface flow of the hospital information system is established according to the user behavior of doctors operating the hospital information system.

At step S316, the analysis server 130 generates a system specification of the information system based on the user interface logic flow. Specifically, the analysis server 130 analyses the logical relationships between operation pages in the user interface flow and transforms the logical relationships between operation pages into structured content of the specification to accurately describe the system functions and interactive behaviors of the information system. Through automatic generation based on the UI Flow, the system specification comprehensively and accurately reflects the actual user behavior, reduce errors and deviations in manual writing, and significantly improves the efficiency and accuracy of requirement analysis.

At step S318, the analysis server 130 generates test cases and test scripts for the information system based on the user interface logic flow. Test cases are testing units designed for specific functions or operation processes of the information system, including test targets, input conditions, execution steps, and expected results. Test scripts are programs or instruction sets executable by automated testing tools, which automatically execute tests according to the steps of test cases and record test results. Specifically, the reconstructed user interface flow is further applied to the generation of test cases and test scripts. In an embodiment, the analysis server 130 automatically generates test cases covering complete operation processes and ensures that test scripts accurately simulate actual user behaviors to improve the comprehensiveness and efficiency of testing.

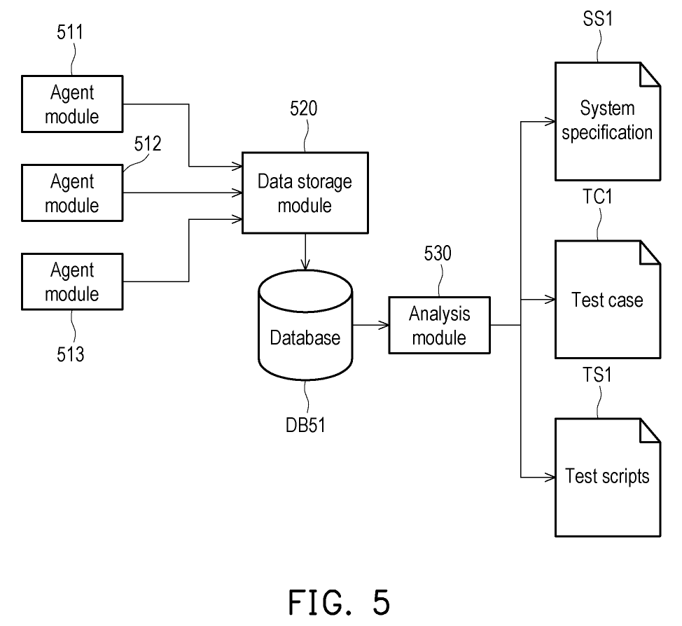

Please refer to FIG. 5, which is a schematic diagram of a method for generating digital asset illustrated according to an embodiment of this disclosure. Agent modules 511 to 513 are deployed on multiple user terminal devices. Agent modules 511 to 513 respectively collect user behavior data on different user terminal devices, and transmit the user behavior data to the data storage module 520. The data storage module 520 receives user behavior data from the agent modules 511 to 513, and performs data cleaning and data structuring processing, then stores the structured data in the database DB51. The analysis module 530 analyses user behavior data to generate user interface flow (UI Flow), and generates system specification SS1, test case TC1 and test scripts TS1 according to the UI Flow.

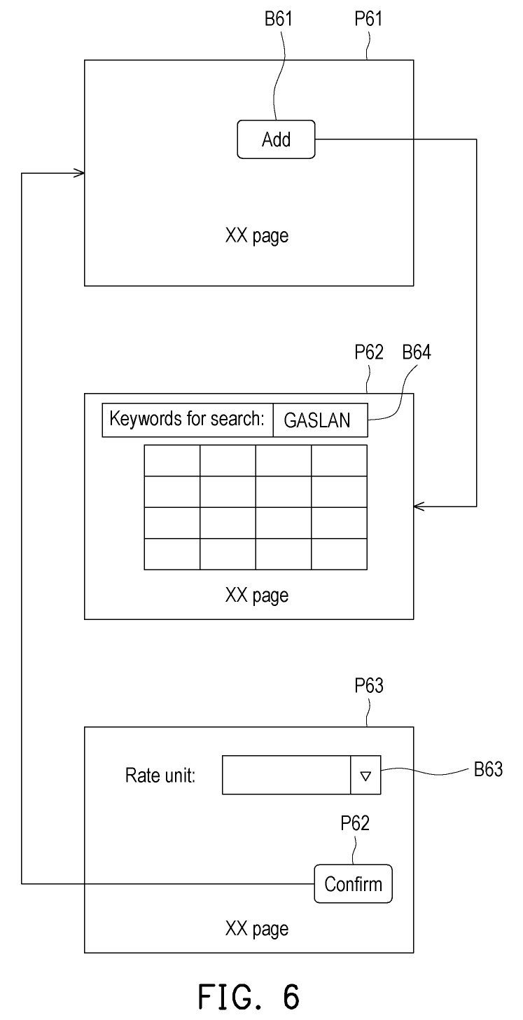

Please refer to FIG. 6, which is a schematic diagram of a user interface flow illustrated according to an embodiment of this disclosure. The user interface flow comprises multiple UI pages P61 to P63 of the information system. Each UI page P61 to P63 comprises one or more UI elements.

The UI page P61 is the starting point of the operation process. The UI page P61 contains an "Add" button B61. When the user clicks the button B61, the action triggers a page navigated to the UI page P62. In the UI page P62, the user inputs query content in the search box B64, such as "GASLAN", and view the search results through the result table L61.

Next, the user navigates from the UI page P62 to the UI page P63 according to requirements. When the user clicks on an item in the result table L61, the action triggers a page navigated to the UI page P63. The UI page P63 provides a "Rate Unit" dropdown menu B63, which is used for selecting related unit settings. In the meantime, the UI page P63 also contains a "Confirm" button B62. When the user completes the settings and clicks the "Confirm" button B62, the system will submit the settings and execute related functions. This operation marks the end point of the process and navigates back to the UI page P61.

The logical navigations between each of the UI pages P61 to P31 are driven by user operation events (such as button clicks, text input), and these user operation events are reflected in the UI Flow. This process not only shows the sequence of user operations, but also reveals the interaction logic between various UI pages P61 to P31 and their internal UI elements, thereby constructing a complete user’s operation path. The generation of this user interface flow is not only be used to accurately describe the functional requirements of the system, but also provides a basis for the generation of test cases and test scripts.

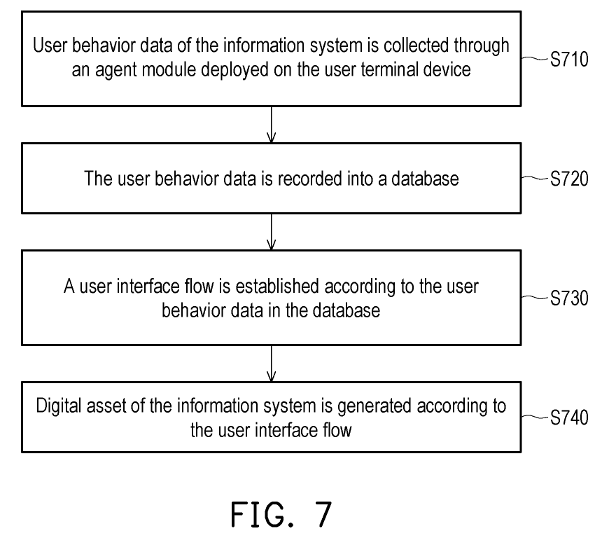

Please refer to FIG. 7, which is a flowchart of a method for generating digital asset based on user behavior illustrated according to an embodiment of this disclosure. At step S710, user behavior data of the information system is collected through an agent module deployed on the user terminal device. At step S720, the user behavior data is recorded into a database. At step S730, a user interface flow is established according to the user behavior data in the database. At step S740, digital asset of the information system is generated according to the user interface flow. However, each step in FIG. 7 has been explained in detail as above, so the description will not be repeated here. In addition, the method of FIG. 7 is used in conjunction with the above exemplary embodiments, or is used independently, and this disclosure does not impose any limitations herein.

To sum up, in the embodiment of the present disclosure, the agent module deployed on the user terminal device collects user behavior data of users operating the information system. Afterwards, the user interface flow of the information system is established according to the user behavior data, and digital asset of the information system, such as system specification, test cases or test scripts, is generated according to the user interface flow. In this way, the dependence on manual interviews is reduced, and the process of generating digital asset is automated to improve efficiency and accuracy. In addition, through the removal of personal data, the security of personal privacy is also be ensured.

Although this disclosure has been disclosed in the embodiments as above, it is not intended to limit this disclosure. Any person with ordinary knowledge in the relevant technical field may make some modifications and refinements without departing from the spirit and scope of this disclosure. Therefore, the scope to be protected by this disclosure should be defined by the appended claims and their equivalents.

What is claimed is:

1. A method for generating digital asset based on user behavior, comprising:
collecting user behavior data of an information system through an agent module deployed on a user terminal device;
recording the user behavior data into a database;
establishing a user interface (UI) flow based on the user behavior data in the database; and
generating digital asset of the information systems based on the user interface flow.

2. The method for generating the digital asset based on the user behavior according to claim 1, wherein after the step of collecting the user behavior data of the information system through the agent module deployed on the user terminal device, the method further comprising:
removing personal data from the user behavior data.

3. The method for generating the digital asset based on the user behavior according to claim 1, wherein the step of collecting the user behavior data of the information system through the agent module deployed on the user terminal device comprises:
extracting a plurality of operation screen frames of the information system through the agent module deployed on the user terminal device;
monitoring a user operation event;
selecting a key frame corresponding to the user operation event from the plurality of operation screen frames according to the user operation event to obtain the user behavior data comprising the key frame and the user operation event.

4. The method for generating the digital asset based on the user behavior according to claim 3, wherein the user operation event comprises mouse click events, touch click events, or keypress events.

5. The method for generating the digital asset based on the user behavior according to claim 3, wherein the step of establishing the user interface flow according to the user behavior data in the database comprises:
determining a correlation between a plurality of system functions in the user interface flow according to an event time of the user operation event of the user behavior data.

6. The method for generating the digital asset based on the user behavior according to claim 1, wherein the step of recording the user behavior data into the database comprises:
performing data structuring processing on the user behavior data to generate structured data; and
recording the structured data into the database.

7. The method for generating the digital asset based on the user behavior according to claim 1, wherein the step of generating the digital asset of the information system according to the user interface flow comprises:
generating a system specification of the information system according to the user interface flow.

8. The method for generating the digital asset based on the user behavior according to claim 1, wherein the step of generating the digital asset of the information system according to the user interface flow comprises:
generating test cases and test scripts of the information system according to the user interface flow.

9. The method for generating the digital asset based on the user behavior according to claim 1, wherein the information system comprises a hospital information system (HIS).

10. A system for generating digital asset based on user behavior, comprising:
a storage device, recording a plurality of instructions; and
a processor, connected to the storage device, and configured to execute the instructions to:
collect user behavior data of an information system through an agent module deployed on a user terminal device;
record the user behavior data into a database;
establish a user interface flow according to the user behavior data in the database; and
generate the digital asset of the information system according to the user interface flow.
